(19) United States
(12) Patent Application Publication
(10) Pub. No.: US 2023/0278388 A1
(43) Pub. Date: Sep. 7, 2023

(54) AIR CONDITIONER FOR A VEHICLE

(71) Applicants: HYUNDAI MOTOR COMPANY, Seoul (KR); KIA CORPORATION, Seoul (KR)

(72) Inventors: Byeong Moo Jang, Suwon-si (KR); Young Tae Song, Gwangmyeong-si (KR); Jae Sik Choi, Suwon-si (KR)

(73) Assignees: HYUNDAI MOTOR COMPANY, Seoul (KR); KIA CORPORATION, Seoul (KR)

(21) Appl. No.: 17/948,960

(22) Filed: Sep. 20, 2022

(30) Foreign Application Priority Data
Mar. 7, 2022 (KR) 10-2022-0028822

(51) Int. Cl. B60H 1/00

(52) U.S. Cl. CPC B60H 1/00064; B60H 1/00564

(57) ABSTRACT

An air conditioner for a vehicle, includes a blower unit, having a blower fan and a filter, disposed on an outer surface opposite to an interior space in a dash panel of the vehicle. The air conditioner includes a HVAC unit disposed on the outer surface opposite to the interior space to introduce air from the blower unit. The HVAC unit has a cooler and a heater therein to divide the air introduced from the blower unit into cold air and hot air through the cooler and the heater and to discharge the air and has a distribution unit disposed on an inner surface facing the interior space to introduce the cold air and the hot air generated by the HVAC unit. The distribution unit has front and rear seat doors configured to adjust a degree of mixing of the cold air and the hot air.

### CROSS REFERENCE TO RELATED APPLICATION

The present application claims priority to Korean Patent Application No. 10-2022-0028822 filed Mar. 7, 2022, the entire contents of which are incorporated herein for all purposes by this reference.

### BACKGROUND

### Technical Field

The present disclosure relates to an air conditioner for a vehicle, and more particularly, to an air conditioner for a vehicle, in which a heating, ventilation, and air-conditioning (HVAC) unit and a distribution unit have an improved internal structure. The improved internal structure individually controls a temperature of air discharged to an interior of the vehicle and a blower unit is separated from the HVAC unit while optimizing arrangement of the HVAC unit, the blower unit, and the distribution unit.

### DESCRIPTION OF THE RELATED ART

In general, a vehicle is equipped with an air conditioner, and includes a heating and cooling system to provide cold air or hot air to the interior thereof. Such an air conditioner typically utilizes a heat pump system. In particular, since an eco-friendly vehicle such as an electric vehicle or a fuel cell vehicle has no engine coolant, it mainly uses a heat pump air conditioner capable of heating and cooling the interior of the vehicle without engine coolant.

A typical heat pump air conditioner includes an HVAC unit having an air inlet and an air outlet, a blower unit installed at the air inlet of the HVAC unit, and a distribution unit. The distribution unit is connected to the air outlet of the HVAC unit to distribute air to each point within a vehicle.

The HVAC unit is provided therein with an evaporator for cooling, a condenser and a heater for heating, and the like to generate cold air and hot air. The cold air and the hot air generated by the HVAC unit are distributed to the interior of the vehicle through the distribution unit.

A conventional air conditioner for a vehicle has a problem in that it takes up a lot of interior space since an HVAC unit and a distribution unit, including a blower unit, are disposed inside the dashboard of the vehicle.

To solve this problem, the entire configuration of the air conditioner has been disposed outside the dashboard of the vehicle such as in an engine room. However, since the distribution unit is disposed outside, there is a problem in that a separate new duct structure must be developed to form a structure connected to an air-conditioning duct located in the rear seat of the vehicle.

Moreover, the number of vehicles equipped with a console therein is increasing in recent years in order to improve user convenience, but a vehicle equipped with a console may have a more complicated internal structure.

The conventional air conditioner for the vehicle includes the blower unit installed at the air inlet of the HVAC unit. Hence, if the blower unit needs to be replaced due to accumulation of foreign substances such as fallen leaves or dust on or in the air inlet or the filter of the blower unit through which outdoor air is introduced, the entire HVAC unit must be removed from the vehicle to replace the blower unit.

In addition, since the blower unit is installed in the HVAC unit, it is difficult to ensure sufficient space to form an air passage through which air flows in the HVAC unit and the air passage may have a complicated structure. Due to the complicated internal structure, it is difficult to individually control the temperature of the air discharged to each point of the vehicle.

The foregoing is intended merely to aid in understanding the background of the present disclosure. The foregoing is not intended to mean that the present disclosure falls within the purview of the related art that is already known to those having ordinary skill in the art.

### SUMMARY

Accordingly, the present disclosure has been made keeping in mind the above problems occurring in the related art. The present disclosure is intended to propose an air conditioner for a vehicle, in which the air conditioner is capable of individually controlling the temperature of air discharged to air-conditioning ducts disposed on front and rear seats and left and right seats of the vehicle. The air conditioner does so by providing a separation door in a heating, ventilation, and air-conditioning (HVAC) unit. The separation door in the HVAC unit adjusts an amount of air introduced into each of a plurality of passages formed to be separated in vertical and horizontal directions. The air conditioner is capable of individually controlling the temperature of air by additionally providing front and rear seat doors in a distribution unit to selectively mix air that has passed through the separation door and to discharge the air to each point of the vehicle.

In accordance with an aspect of the present disclosure, an air conditioner for a vehicle includes a blower unit. The blower unit disposed on an outer surface opposite to an interior space in a dash panel of the vehicle and has a blower fan and a filter. The air conditioner further includes an HVAC unit disposed on the outer surface opposite to the interior space in the dash panel of the vehicle and coupled to the side of the blower unit to introduce air from the blower unit. The HVAC unit has a cooler and a heater therein to divide the air introduced from the blower unit into cold air and hot air through the cooler and the heater and to discharge the air. The air conditioner also includes a distribution unit disposed on an inner surface facing the interior space in the dash panel of the vehicle to introduce the cold air and the hot air generated by the HVAC unit. The distribution unit has a front seat door configured to adjust a degree of mixing of the cold air and the hot air provided to a front seat and a rear seat door configured to adjust a degree of mixing of the cold air and the hot air provided to a rear seat.

In the air conditioner, the blower unit, the HVAC unit, and the distribution unit may be individually and detachably coupled to each other.

In the air conditioner, the HVAC unit may further include a cold air passage in which the cooler is installed, a hot air passage in which the heater is installed, and a separation door. The separation door may be disposed between the cold air passage and the hot air passage and separately arranged at an inlet of each passage to adjust an amount of air introduced into each passage.

In the air conditioner, each of the cold air passage and the hot air passage may be separated, by a separation plate formed in the center thereof, into a left air passage and a right air passage. The left air passage may communicate with an air-conditioning duct disposed on a left seat of the vehicle, and the right air passage may communicate with an air-conditioning duct disposed on a right seat of the vehicle. The separation door may be separately arranged at each inlet of the left and right air passages.

In the air conditioner, the cold air passage may include a first passage disposed above the hot air passage to communicate with an air-conditioning duct disposed on the front seat of the vehicle. The cold air passage may further include a second passage disposed beneath the hot air passage to communicate with an air-conditioning duct disposed on the rear seat of the vehicle.

In the air conditioner, the distribution unit may include a first distribution part having one side connected to an outlet of the first passage and the other side connected to the air-conditioning duct disposed on the front seat of the vehicle. The distribution unit may further include a second distribution part having one side connected to an outlet of the second passage and the other side connected to the air-conditioning duct disposed on the rear seat of the vehicle. Furthermore, the distribution unit may include a mixing part connected to an outlet of the hot air passage.

In the air conditioner, the front seat door may be disposed between the first distribution part and the mixing part, and the rear seat door may be disposed between the second distribution part and the mixing part.

In the air conditioner, each of the first distribution part, the second distribution part, and the mixing part may be separated, by a separation plate formed in the center thereof, into a left distribution part and a right distribution part. The left distribution part may be connected to an air-conditioning duct disposed on a left seat of the vehicle. The right distribution part may be connected to an air-conditioning duct disposed on a right seat of the vehicle.

In the air conditioner, the front seat door may be separately arranged at each inlet of the left and right distribution parts.

In the air conditioner, the rear seat door may be separately arranged at each inlet of the left and right distribution parts.

In the air conditioner, the separation door may include an upper separation door disposed between respective inlets of the first passage and the hot air passage. The separation door may further include a lower separation door disposed between respective inlets of the hot air passage and the second passage.

In the air conditioner, the separation door, the front seat door, and the rear seat door may each have a flat plate shape and be installed to be slidable vertically so as to adjust an amount of air introduced into the cold air passage and the hot air passage depending on the sliding direction thereof.

In the air conditioner, the separation door, the front seat door, and the rear seat door may each have a fanwise dome shape and be rotatably installed so as to adjust an amount of air introduced into the cold air passage and the hot air passage depending on the angle of rotation thereof.

As apparent from the above description, according to the air conditioner for the vehicle of the present disclosure, it is possible to individually control the temperature of the air discharged to the air-conditioning ducts disposed on the front and rear seats and the left and right seats of the vehicle by providing the separation door in the HVAC unit. The separation door in the HVAC unit adjusts the amount of air introduced into each of the plurality of passages formed to be separated in the vertical and horizontal directions. Further, it is possible to individually control the temperature of the air discharged to the air-conditioning ducts by additionally providing the front and rear seat doors in the distribution unit to selectively mix air that has passed through the separation door and to discharge the air to each point of the vehicle.

In addition, it is possible to maximize the utilization of the interior space of the vehicle by disposing the HVAC and blower units outside the dash panel of the vehicle and disposing the distribution unit inside the dash panel. Further, by individually detaching the HVAC unit, the blower unit, and the distribution unit from each other, the efficiency of the manufacturing process and A/S (After Service) is improved.

### BRIEF DESCRIPTION OF THE DRAWINGS

The above and other objects, features, and advantages of the present disclosure should be more clearly understood from the following detailed description taken in conjunction with the accompanying drawings, in which:

FIG. 1 is a view illustrating an internal structure of a heating, ventilation, and air-conditioning (HVAC) unit and a distribution unit according to an embodiment of the present disclosure;

FIG. 2 is a view illustrating an internal structure of a blower unit according to the embodiment of the present disclosure;

FIG. 3 is a view schematically illustrating an arrangement of the blower unit, the HVAC unit, and the distribution unit according to the embodiment of the present disclosure;

FIG. 4 is a view schematically illustrating that the air conditioner for a vehicle is installed in the vehicle in the state of FIG. 3 according to the embodiment of the present disclosure;

FIG. 5 is a cross-sectional view taken along line “A-A” of FIG. 1; and

FIG. 6 is a cross-sectional view illustrating another example of FIG. 5.

### DESCRIPTION OF EMBODIMENTS

It should be understood herein that when a component is referred to as “comprising” or “including” any component, it does not exclude other components, but can further comprise or include the other components unless otherwise specified.

In addition, the terms such as “first” and/or “second” may be used to describe different components. These terms are used merely to distinguish the corresponding component from other components. For example, without departing from the scope of the concept underlying the present disclosure, the first component may be referred to as the second component, and similarly, the second component may also be referred to as the first component.

Hereinafter, the configuration and operation of various embodiments of the present disclosure are described in detail with reference to the accompanying drawings.

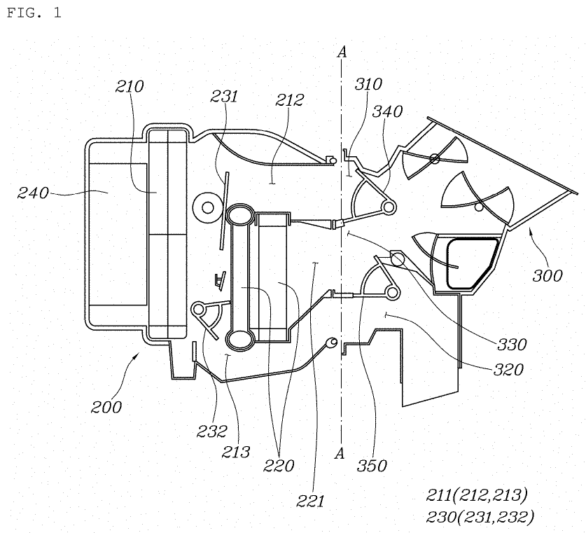

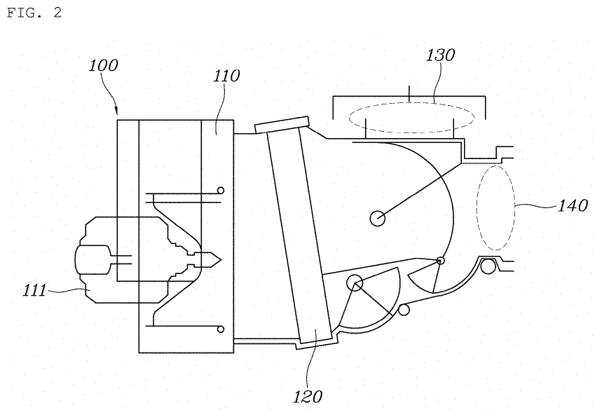

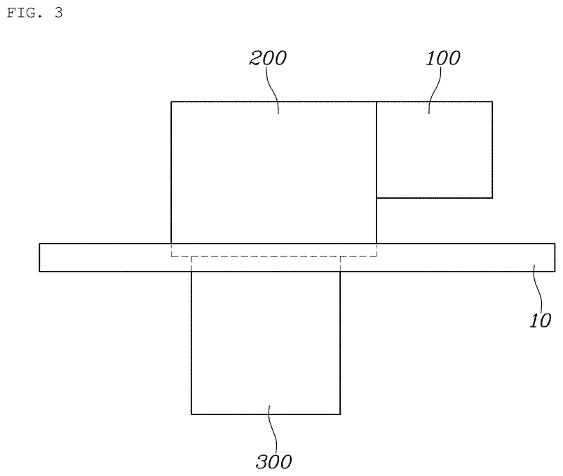

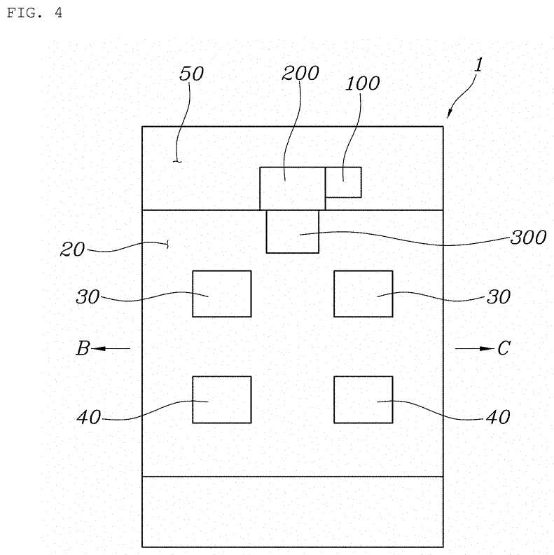

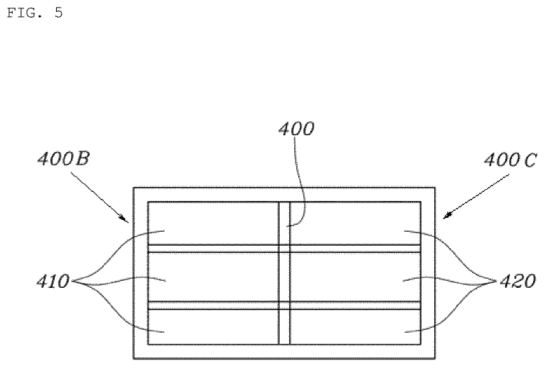

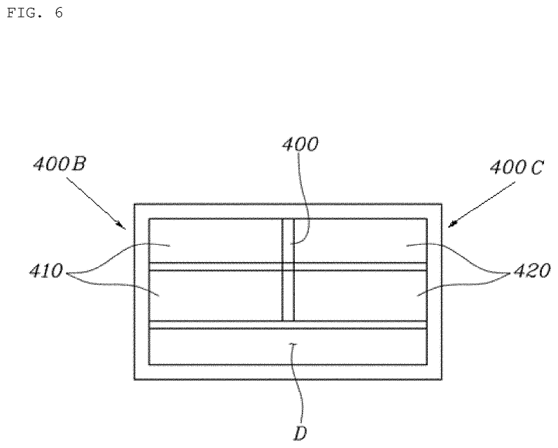

FIG. 1 is a view illustrating an internal structure of a heating, ventilation, and air-conditioning (HVAC) unit 200 and a distribution unit 300 according to an embodiment of the present disclosure. FIG. 2 is a view illustrating an internal structure of a blower unit 100 according to the embodiment of the present disclosure. FIG. 3 is a view schematically illustrating an arrangement of the blower unit 100, the HVAC unit 200, and the distribution unit 300 according to the embodiment of the present disclosure. FIG. 4 is a view schematically illustrating that the air conditioner for a vehicle 1 is installed in the vehicle 1 in the state of FIG. 3 according to the embodiment of the present disclosure. FIG. 5 is a cross-sectional view taken along line “A-A” of FIG. 1. FIG. 6 is a cross-sectional view illustrating another example of FIG. 5.

Referring to FIGS. 1-4, the air conditioner for the vehicle 1 according to the present disclosure includes a blower unit 100 disposed on an outer surface opposite to an interior space 20 in a dash panel 10 of the vehicle 1. The blower unit 100 has a blower fan 110 and a filter 120. The air conditioner further includes a HVAC unit 200 disposed on the outer surface opposite to the interior space 20 in the dash panel 10 of the vehicle 1 and coupled to the side of the blower unit 100 to introduce air from the blower unit 100. The HVAC unit 200 has a cooler 210 and a heater 220 therein to divide the air introduced from the blower unit 100 into cold air and hot air through the cooler 210 and the heater 220 and to discharge the air. The air conditioner further includes a distribution unit 300 disposed on an inner surface facing the interior space 20 in the dash panel 10 of the vehicle 1 to introduce the cold air and the hot air generated by the HVAC unit 200. The distribution unit has a front seat door 340 configured to adjust a degree of mixing of the cold air and the hot air provided to a front seat and a rear seat door 350 configured to adjust a degree of mixing of the cold air and the hot air provided to a rear seat 40.

In order to help understand the present disclosure, key features of components of the present disclosure are described together with the internal structure of a typical air conditioner for a vehicle 1.

A typical heat pump air conditioner includes an HVAC unit 200 having an air inlet and an air outlet, a blower unit 100 installed at the air inlet of the HVAC unit 200, and a distribution unit 300 connected to the air outlet of the HVAC unit 200 to distribute air to each point within the vehicle 1.

The HVAC unit 200 is provided therein with an evaporator for cooling, a condenser and a heater for heating, and the like to generate cold air and hot air. The cold air and the hot air generated by the HVAC unit 200 are distributed to the interior of the vehicle 1 through the distribution unit 300.

In other words, the air conditioner for the vehicle 1 according to the present disclosure includes the blower unit 100, the HVAC unit 200, and the distribution unit 300 as basic components.

For reference, it may be understood that “each point within the vehicle 1” refers to an installation point of an air-conditioning duct through which cold air and hot air provided from the air conditioner are discharged to the interior. More specifically, “each point within the vehicle 1” refers to an installation point of an air-conditioning duct in each seat (left and right seats or front and rear seats) of the vehicle 1 to provide air at an appropriate temperature to a user seated on the seat.

However, the air-conditioning duct installed at each point within the vehicle 1 may be installed outside the seat, such as the front or side of the seat, rather than inside the seat, depending on the requirements of a design. It should be understood that the air-conditioning duct is installed in the vicinity of the seat of the vehicle 1 to provide air at an appropriate temperature to a user seated on the seat.

A conventional air conditioner for a vehicle 1 has a problem in that it takes up a lot of interior space 20 since a HVAC unit 200 and a distribution unit 300, including a blower unit 100, are disposed inside the dashboard of the vehicle 1.

On the other hand, when the HVAC unit 200 and the distribution unit 300, including the blower unit 100, are disposed outside the dashboard of the vehicle 1, such as in an engine room, there is a problem in that a separate new duct structure must be developed to form a structure connected to an air-conditioning duct located in the rear seat 40 of the vehicle 1 since the distribution unit 300 is disposed outside.

Accordingly, in the air conditioner for the vehicle 1 according to the present disclosure, the HVAC unit 200 and the blower unit 100 are disposed outside the dash panel 10 of the vehicle 1 and the distribution unit 300 is disposed inside the dash panel 10 in order to maximize the utilization of the interior space 20 of the vehicle 1.

In addition, the conventional air conditioner for the vehicle 1 includes the blower unit 100 installed at the air inlet of the HVAC unit 200. Hence, if A/S (After Service) of the blower unit 100 is required, the entire HVAC unit 200 must be separated from the vehicle 1 to replace the blower unit 100. In addition, it is difficult to ensure sufficient space to form an air passage through which air flows in the HVAC unit 200. It is also difficult to individually control the temperature of the air discharged to each point of the vehicle 1 due to the complicated structure of the air passage.

Accordingly, the air conditioner for the vehicle 1 according to the present disclosure is intended to easily implement a structure in which the HVAC unit 200 and the blower unit 100 are separated to perform A/S of the blower unit 100 without separation of the HVAC unit 200. The HVAC unit 200 has sufficient internal space to simplify the structure of the complicated air passage for facilitating the manufacturing process, and the temperature of the air discharged to each point of the vehicle 1 is individually controlled.

Hereinafter, the technical features of each component of the present disclosure are described in more detail with reference to FIGS. 1-4.

Specifically, referring to FIG. 2, in the air conditioner for the vehicle 1 according to the present disclosure, the blower unit 100 has an outdoor air inlet 130 for the introduction of outdoor air and an indoor air inlet 140 for the introduction of indoor air. As a blower fan 110 is rotated by a blower motor 111, a pressure difference is generated so that air is introduced into the blower unit 100. The air introduced through each inlet passes through a filter 120 to filter out foreign substances.

For reference, it may be understood that the indoor air inlet 140 serves to introduce indoor air into the air conditioner when the air conditioner is operated in an indoor air circulation mode. The outdoor air inlet 130 serves to introduce outdoor air into the air conditioner when the air conditioner is operated in an outdoor air circulation mode. In other words, the air conditioner for the vehicle 1 introduces indoor air or outdoor air for cooling or heating, and then discharges the cooled or heated air into the interior.

Subsequently, referring to FIG. 1, the air introduced by the blower unit 100 flows into the HVAC unit 200 through a connection passage 240 of the HVAC unit 200. The air introduced into the HVAC unit 200 is low-temperature cold air while passing through the cooler 210. The low-temperature cold air is discharged to each point of the vehicle 1 through the distribution unit 300 for cooling.

On the other hand, the low-temperature cold air may be changed to high-temperature hot air while passing through the heater 220, and the hot air is discharged to each point of the vehicle 1 through the distribution unit 300 for heating.

In other words, in the air conditioner for the vehicle 1, according to the present disclosure, the air introduced from the blower unit 100 is divided into cold air and hot air through the cooler 210 and the heater 220 provided in the HVAC unit 200, and then discharged.

For reference, the cooler 210 may include an evaporator and the heater 220 may include a condenser and a heater. In particular, FIG. 1 illustrates a condenser and a positive temperature coefficient (PTC) heater as the heater 220. However, this is only an example to help understand the present disclosure, and the content of the present disclosure is not limited by these examples.

Referring to FIGS. 3 and 4, in the air conditioner for the vehicle 1 according to the present disclosure, the blower unit 100 and the HVAC unit 200 are disposed outside the dash panel 10 of the vehicle 1, and the distribution unit 300 is disposed inside the dash panel 10. The exterior of the vehicle 1 refers to an area in which the engine room 50 of the vehicle 1 is located, and the interior refers to the same area as the space occupied by the user of the vehicle 1. In other words, the dash panel 10 of the vehicle 1 may be located in the area of “A-A” in FIG. 1. It may be understood that the left side refers to the exterior and the right side refers to the interior with respect to the “A-A.”

As such, since the HVAC unit 200 and the blower unit 100 are disposed in the exterior, except for the distribution unit 300, the utilization of the interior space 20 of the vehicle 1 may be maximized. In addition, the distribution unit 300 disposed in the interior may more simply implement a structure connected to the air-conditioning duct located in the rear seat of the vehicle 1 even if a separate new duct structure is not developed.

In the air conditioner for the vehicle 1, according to the present disclosure, the blower unit 100, the HVAC unit 200, and the distribution unit 300 may be individually and detachably coupled to each other.

Specifically, in the air conditioner for the vehicle 1 according to the present disclosure, the blower unit 100, the HVAC unit 200, and the distribution unit 300 are individually manufactured and detached from each other. In other words, the HVAC unit 200 is coupled to the side of the blower unit 100, and the HVAC unit 200 and the distribution unit 300 are mounted on opposite sides of the dash panel 10 of the vehicle 1.

Accordingly, when A/S of the blower unit 100 is required, only the blower unit 100 may be removed and replaced without separating the HVAC unit 200 from the vehicle 1, thereby performing A/S with more convenience. Furthermore, when A/S of the HVAC unit 200 and the distribution unit 300 is required, only those units may be removed and replaced.

In the air conditioner for the vehicle 1 according to the present disclosure, the HVAC unit 200 may further include a cold air passage 211 in which the cooler 210 is installed, a hot air passage 221 in which the heater 220 is installed, and a separation door 230. The separation door 230 is disposed between the cold air passage 211 and the hot air passage 221 and separately arranged at the inlet of each passage to adjust an amount of air introduced into each passage.

In other words, in the air conditioner for the vehicle 1 according to the present disclosure, the HVAC unit 200 includes the cooler 210 and the heater 220 therein, and includes the cold air passage 211 in which the cooler 210 is installed and the hot air passage 221 in which the heater 220 is installed, so that the air introduced from the blower unit 100 along each passage is divided into cold air and hot air for discharge.

Furthermore, the separation door 230 is disposed between the cold air passage 211 and the hot air passage 221 to adjust the amount of each of the cold air and the hot air. Accordingly, an appropriate amount of cold air and hot air may be introduced into the distribution unit 300. The cold air and the hot air introduced into the distribution unit 300 may be properly mixed through the front seat door 340 and the rear seat door 350 and then provided to the front and rear seats of the vehicle 1, thereby providing air at an appropriate temperature to the user of the vehicle 1.

In this example, the separation door 230 may include an upper separation door 231 and a lower separation door 232, which are described in detail below.

FIG. 5 is a cross-sectional view taken along line “A-A” of FIG. 1 and FIG. 6 is a cross-sectional view illustrating another example of FIG. 5. FIG. 5 is a cross-sectional view taken along line “A-A” when viewed from the interior of the vehicle toward the exterior thereof.

Referring to FIGS. 5 and 6, in the air conditioner for the vehicle 1 according to the present disclosure, each of the cold air passage 211 and the hot air passage 221 may be separated, by a separation plate 400 formed in the center thereof, into a left air passage 410 and a right air passage 420. The left air passage 410 may communicate with the air-conditioning duct disposed on the left seat of the vehicle 1. The right air passage 420 may communicate with the air-conditioning duct disposed on the right seat of the vehicle 1. The separation door 230 may be separately arranged at each inlet of the left air passage 410 and the right air passage 420.

In other words, the separation plate 400 formed in the center of each of the cold air passage 211 and the hot air passage 221 separates each passage into the left air passage 410 and the right air passage 420. Thus, each passage may communicate with the air-conditioning duct disposed on the left or right seat of the vehicle 1.

The separation door 230 may be separately arranged at each inlet and outlet of the left air passage 410 and the right air passage 420 to individually control the temperature of the air discharged to the air-conditioning ducts disposed on the left and right seats of the vehicle 1.

For example, when it is intended to discharge air only to the left seat, the separation door 230 arranged at each inlet and outlet of the left air passage 410 is opened. Further, the separation door 230 arranged at each inlet and outlet of the right air passage 420 is closed. On the other hand, when it is intended to discharge air only to the right seat, the separation door 230 arranged at each inlet and outlet of the right air passage 420 is opened. Further, the separation door 230 arranged at each inlet and outlet of the left air passage 410 is closed.

As a result, by individually controlling the separation door 230 as described above, it is possible to more simply implement a structure in which the temperature of the air discharged to the air-conditioning ducts disposed on the left and right seats of the vehicle 1 is individually controlled.

For reference, it may be understood that the left seat of the vehicle 1 is a seat located on the left side B of the vehicle 1 and includes both front and rear seats located on the left side. The right seat of the vehicle 1 is a seat located on the right side C of the vehicle 1 and includes both the front and rear seats located on the right side.

It may be understood that the left air passage 410 includes both the cold air passage 211 and the hot air passage 221 located on the left side B of the vehicle 1. It may also be understood that the right air passage 420 includes both the cold air passage 211 and the hot air passage 221 located on the right side C of the vehicle 1.

As illustrated in area “D” of FIG. 6, the cold air passage 211 located beneath the hot air passage 221 may have a structure in which the separation plate 400 is removed. This may be understood to be provided for quickly air-conditioning the entire interior of the vehicle 1. As is discussed below, the cold air passage 211 located beneath the hot air passage 221 may communicate with the air-conditioning duct disposed on the rear seat 40.

Accordingly, when the air conditioner for the vehicle 1 according to the present disclosure has an internal structure as illustrated in area “D” of FIG. 6, it is difficult to individually control the air provided to the rear seat 40 located on the left side B of the vehicle 1 and the air provided to the rear seat 40 located on the right side C of the vehicle 1.

However, since the rear seat 40 has a relatively long airflow path compared to the front seat 30, it is necessary to form a structure as illustrated in FIG. 6 for quickly air-conditioning the entire interior of the vehicle 1. In other words, when it is intended to provide air to the rear seat 40, it is possible to adopt a structure as illustrated in area “D” of FIG. 6 in which the separation plate 400 is removed, if necessary, for quickly air-conditioning the entire interior of the vehicle 1.

FIG. 1 is a view illustrating the internal structure of the HVAC unit 200 and the distribution unit 300 according to the embodiment of the present disclosure.

Referring to FIG. 1, in the air conditioner for the vehicle 1 according to the present disclosure, the cold air passage 211 may include a first passage 212 disposed above the hot air passage 221 to communicate with the air-conditioning duct disposed on the front seat 30 of the vehicle 1. The cold air passage 211 may also include a second passage 213 disposed beneath the hot air passage 221 to communicate with the air-conditioning duct disposed on the rear seat 40 of the vehicle 1.

In the air conditioner for the vehicle 1 according to the present disclosure, the separation door 230 may include an upper separation door 231 disposed between the respective inlets of the first passage 212 and the hot air passage 221. The separation door 230 may also include a lower separation door 232 disposed between the respective inlets of the hot air passage 221 and the second passage 213.

In other words, the cold air passage 211 includes the first passage 212 disposed above the hot air passage 221 and the second passage 213 disposed beneath the hot air passage 221. As described above, the second passage 213 disposed beneath the hot air passage 221 communicates with the air-conditioning duct disposed on the rear seat 40 of the vehicle 1. The first passage 212 disposed above the hot air passage 221 communicates with the air-conditioning duct disposed on the front seat 30 of the vehicle 1.

The separation door 230 may include the upper separation door 231 and the lower separation door 232 arranged as described above, thereby individually controlling the temperature of the air discharged to the air-conditioning ducts disposed on the front and rear seats of the vehicle 1.

For example, when it is intended to provide only hot air to the front seat 30 and only cold air to the rear seat 40, the upper separation door 231 is controlled to close the first passage 212 and open the hot air passage 221 for discharging only hot air to the distribution unit 300. Likewise, the lower separation door 232 is controlled to open the second passage 213 and close the hot air passage 221 for discharging only cold air to the distribution unit 300.

On the other hand, when it is intended to provide only cold air to the front seat 30 and only hot air to the rear seat 40, the upper separation door 231 slides downward in the state illustrated in FIG. 1 to close the hot air passage 221 and open only the first passage 212. The lower separation door 232 is also rotated clockwise in the state illustrated in FIG. 1 to close the second passage 213 and open only the hot air passage 221.

As a result, by individually controlling the upper separation door 231 and the lower separation door 232 as described above, it is possible to simply implement a structure in which the temperature of the air discharged to the air-conditioning ducts disposed on the front and rear seats of the vehicle 1 is individually controlled.

Furthermore, in the air conditioner for the vehicle 1 according to the present disclosure, the distribution unit 300 may include a first distribution part 310 having one side connected to the outlet of the first passage 212 and the other side connected to the air-conditioning duct disposed on the front seat 30 of the vehicle 1. The distribution unit 300 may further include a second distribution part 320 having one side connected to the outlet of the second passage 213 and the other side connected to the air-conditioning duct disposed on the rear seat 40 of the vehicle 1. Furthermore, the distribution unit 300 may include a mixing part 330 connected to the outlet of the hot air passage 221.

In the air conditioner for the vehicle 1 according to the present disclosure, the front seat door 340 may be disposed between the first distribution part 310 and the mixing part 330, and the rear seat door 350 may be disposed between the second distribution part 320 and the mixing part 330.

In other words, the first distribution part 310 of the distribution unit 300 has one side connected to the outlet of the first passage 212 and the other side connected to the air-conditioning duct disposed on the front seat 30 of the vehicle 1. The air that has passed through the upper separation door 231 and the front seat door 340 is thereby enabled to be provided to the front seat 30 of the vehicle 1.

Similarly, the second distribution part 320 of the distribution unit 300 has one side connected to the outlet of the second passage 213 and the other side connected to the air-conditioning duct disposed on the rear seat 40 of the vehicle 1. The air that has passed through the lower separation door 232 and the rear seat door 350 is thereby enabled to be provided to the rear seat 40 of the vehicle 1.

In addition, the mixing part 330 of the distribution unit 300 may be connected to the outlet of the hot air passage 221. Thus, the air that has passed through the hot air passage 221 is selectively mixed with the air that has passed through the first or second passage 212 or 213 and then provided to the front seat 30 or the rear seat 40 of the vehicle 1.

Specifically, the air that has passed through the first passage 212 and the air that has passed through the hot air passage 221 are mixed through the front seat door 340 and then provided to the front seat 30 of the vehicle 1. The air that has passed through the second passage 213 and the air that has passed through the hot air passage 221 are mixed through the rear seat door 350 and then provided to the rear seat 40 of the vehicle 1.

Accordingly, by secondarily mixing the cold air and the hot air primarily controlled through the separation door 230 in the mixing part 330, it is possible to simply implement a structure in which air is provided at an appropriate temperature to the user of the vehicle 1. Further, the temperature of the air discharged to the air-conditioning ducts disposed on the front and rear seats of vehicle 1 is individually controlled.

In the air conditioner for the vehicle 1 according to the present disclosure, each of the first distribution part 310, the second distribution part 320, and the mixing part 330 may be separated, by the separation plate 400 formed in the center thereof, into a left distribution part (400B) and a right distribution part (400C). The left distribution part (400B) may be connected to the air-conditioning duct disposed on the left seat of the vehicle 1, and the right distribution part (400C) may be connected to the air-conditioning duct disposed on the right seat of the vehicle 1. In the air conditioner for the vehicle 1 according to the present disclosure, the front seat door 340 or the rear seat door 350 may be separately arranged at each inlet of the left distribution part (400B) and the right distribution part (400C).

Here, it may be understood that the separation plate 400 formed in the center of each of the cold air passage 211 and the hot air passage 221, as discussed above, extends to the first distribution part 310, the second distribution part 320, and the mixing part 330. In other words, the air introduced into the distribution unit, after being separated from the cold air passage 211 and the hot air passage 221 into the left air passage 410 and the right air passage 420, is separated into the left distribution part (400B) and the right distribution part (400C) in the distribution unit. The air is then discharged to the air-conditioning duct disposed on the left or right seat of the vehicle 1.

Specifically, the separation plate 400 formed in the center of each of the first distribution part 310, the second distribution part 320, and the mixing part 330 may separate each distribution part into the left distribution part (400B) and the right distribution part (400C) to connect each distribution part to the air-conditioning duct disposed on the left or right seat of the vehicle 1. The front seat door 340 and the rear seat door 350 may be separately arranged at the inlet of each distribution part to individually adjust the amount of the air introduced into each distribution part.

Since the first distribution part 310 has one side connected to the outlet of the first passage 212 and the other side connected to the air-conditioning duct disposed on the front seat 30 of the vehicle 1 as described above, the air that has passed through the upper separation door 231 and the front seat door 340 can be provided to the front seat 30 of the vehicle 1 while being individually provided to both the left and right sides of the front seat 30.

Similarly, since the second distribution part 320 has one side connected to the outlet of the second passage 213 and the other side connected to the air-conditioning duct disposed on the rear seat 40 of the vehicle 1 as described above, the air that has passed through the lower separation door 232 and the rear seat door 350 can be provided to the rear seat 40 of the vehicle 1 while being individually provided to both the left and right sides of the rear seat 40.

In addition, since the mixing part 330 is connected to the outlet of the hot air passage 221 as described above, the air that has passed through the hot air passage 221 is selectively mixed with the air that has passed through the first or second passage 212 or 213. The air is then provided to the front seat 30 or the rear seat 40 of the vehicle 1 while being individually provided to both the left and right sides of the front or rear seat.

In the air conditioner for the vehicle 1, according to the present disclosure, the separation door 230, the front seat door 340, and the rear seat door 350 may each have a flat plate shape. The flat plate shape may be installed to slide vertically so as to adjust the amount of air introduced into the cold air passage 211 and the hot air passage 221, depending on the sliding direction thereof. Alternatively, the separation door 230, the front seat door 340, and the rear seat door 350 may each have a fanwise dome shape and be rotatably installed so as to adjust the amount of air introduced into the cold air passage 211 and the hot air passage 221, depending on the angle of rotation thereof.

In other words, the separation door 230, the front seat door 340, and the rear seat door 350 may each have one of the flat shape and the dome shape if necessary. Although FIG. 1 illustrates that the upper separation door 231 has a flat shape, and the lower separation door 232, the front seat door 340, and the rear seat door 350 each have a dome shape, the present disclosure is not limited thereto. They may have different shapes according to particular design needs. In other words, this is only an example to help understand the present disclosure. The content of the present disclosure is not limited by these examples.

When the separation door 230, the front seat door 340, and the rear seat door 350 each have a flat plate shape, they may be installed to slide vertically. This makes it possible to open and close a large area with a minimum configuration, which is the most beneficial in terms of cost reduction.

When the separation door 230, the front seat door 340, and the rear seat door 350 each have a fanwise dome shape, they may be installed to be rotatable within a predetermined angle. This makes it possible not only to open and close the cooling passage and the hot air passage 221 with a single door, but also to selectively mix cold air and hot air.

Furthermore, when each door has a fanwise dome shape, it is possible to prevent a decrease in durability performance due to generation of overload on the rotary shaft by the introduction of air during rotation operation. In addition, when the cold air passage 211 and the hot air passage 221 are completely opened or closed, it is possible to increase a sealing effect by increasing the contact area with each passage.

For reference, in the air conditioner for the vehicle 1 according to the present disclosure, it is natural that the separation door 230, the front seat door 340, and the rear seat door 350 may be slid or have an adjustable angle of rotation by an actuation motor operated by a separate controller.

Accordingly, as described above, the air conditioner for the vehicle 1 of the present disclosure makes it possible to individually control the temperature of air discharged to the air-conditioning ducts disposed on the front and rear seats and the left and right seats of the vehicle 1 by providing the separation door 230 in the HVAC unit 200. The separation door 230 adjusts the amount of air introduced into each of the plurality of passages formed to be separated in the vertical and horizontal directions. Further, it is possible to individually control the temperature of air by additionally providing the front and rear seat doors 340 and 350 in the distribution unit 300 to selectively mix air that has passed through the separation door 230 and to discharge the air to each point of the vehicle 1. In addition, it is possible to maximize the utilization of the interior space 20 of the vehicle 1 by disposing the HVAC unit 200 and the blower unit 100 outside the dash panel 10 of the vehicle 1 and disposing the distribution unit 300 inside the dash panel 10. Further, by individually detaching the HVAC unit 200, the blower unit 100, and the distribution unit 300 from each other, the efficiency of the manufacturing process and A/S is improved.

Although specific embodiments of the present disclosure have been described for illustrative purposes, those having ordinary skill in the art should appreciate that various modifications, additions, and substitutions are possible without departing from the scope and spirit of the inventive concept as disclosed in the accompanying claims.

What is claimed is:

1. An air conditioner for a vehicle, comprising:
a blower unit disposed on an outer surface opposite to an interior space in a dash panel of the vehicle, the blower unit having a blower fan and a filter;
a heating, ventilation, and air-conditioning (HVAC) unit disposed on the outer surface opposite to the interior space in the dash panel of the vehicle and coupled to a side of the blower unit to introduce air from the blower unit, the HVAC unit having a cooler and a heater therein to divide the air introduced from the blower unit into cold air and hot air through the cooler and the heater and to discharge the air; and
a distribution unit disposed on an inner surface facing the interior space in the dash panel of the vehicle to introduce the cold air and the hot air generated by the HVAC unit, the distribution unit having a front seat door configured to adjust a degree of mixing of the cold air and the hot air provided to a front seat and a rear seat door configured to adjust a degree of mixing of the cold air and the hot air provided to a rear seat.

2. The air conditioner according to claim 1, wherein the blower unit, the HVAC unit, and the distribution unit are individually and detachably coupled to each other.

3. The air conditioner according to claim 1, wherein the HVAC unit further comprises a cold air passage in which the cooler is installed, a hot air passage in which the heater is installed, and a separation door disposed between the cold air passage and the hot air passage and separately arranged at an inlet of each passage to adjust an amount of air introduced into each passage.

4. The air conditioner according to claim 3, wherein each of the cold air passage and the hot air passage is separated, by a separation plate formed in the center thereof, into a left air passage and a right air passage, the left air passage communicates with an air-conditioning duct disposed on a left seat of the vehicle, and the right air passage communicates with an air-conditioning duct disposed on a right seat of the vehicle, and
the separation door is separately arranged at each inlet of the left and right air passages.

5. The air conditioner according to claim 3, wherein the cold air passage includes a first passage disposed above the hot air passage to communicate with an air-conditioning duct disposed on the front seat of the vehicle and a second passage disposed beneath the hot air passage to communicate with an air-conditioning duct disposed on the rear seat of the vehicle.

6. The air conditioner according to claim 5, wherein the distribution unit comprises:
a first distribution part having one side connected to an outlet of the first passage and the other side connected to the air-conditioning duct disposed on the front seat of the vehicle;
a second distribution part having one side connected to an outlet of the second passage and the other side connected to the air-conditioning duct disposed on the rear seat of the vehicle; and
a mixing part connected to an outlet of the hot air passage.

7. The air conditioner according to claim 6, wherein the front seat door is disposed between the first distribution part and the mixing part, and wherein the rear seat door is disposed between the second distribution part and the mixing part.

8. The air conditioner according to claim 6, wherein each of the first distribution part, the second distribution part, and the mixing part is separated, by a separation plate formed in the center thereof, into a left distribution part and a right distribution part, and
the left distribution part is connected to an air-conditioning duct disposed on a left seat of the vehicle, and the right distribution part is connected to an air-conditioning duct disposed on a right seat of the vehicle.

9. The air conditioner according to claim 8, wherein the front seat door is separately arranged at each inlet of the left and right distribution parts.

10. The air conditioner according to claim 8, wherein the rear seat door is separately arranged at each inlet of the left and right distribution parts.

11. The air conditioner according to claim 5, wherein the separation door includes an upper separation door disposed between respective inlets of the first passage and the hot air passage and a lower separation door disposed between respective inlets of the hot air passage and the second passage.

12. The air conditioner according to claim 3, wherein the separation door, the front seat door, and the rear seat door each have a flat plate shape and are slidable vertically so as to adjust an amount of air introduced into the cold air passage and the hot air passage depending on the sliding direction thereof.

13. The air conditioner according to claim 3, wherein the separation door, the front seat door, and the rear seat door each have a fanwise dome shape and are rotatably installed so as to adjust an amount of air introduced into the cold air passage and the hot air passage depending on an angle of rotation thereof.
